(19) United States
(12) Patent Application Publication
(10) Pub. No.: US 2017/0204283 A1
(43) Pub. Date: Jul. 20, 2017

(54) COATING COMPOSITIONS AND METHODS OF APPLYING A COATING

(71) Applicant: Carlisle Construction Materials Incorporated, Carlisle, PA (US)

(72) Inventors: Alexandra Lewis, Wylie, TX (US); Daniel J. Cotsakis, Rockwall, TX (US)

(73) Assignee: Carlisle Construction Materials Incorporated, Carlisle, PA (US)

(21) Appl. No.: 15/326,591

(22) PCT Filed: Jul. 14, 2015
(86) PCT No.: PCT/US2015/040265

§ 371 Date: Jan. 16, 2017

Related U.S. Application Data
(60) Provisional application No. 62/024,298, filed on Jul. 14, 2014.

(51) Int. Cl. C09D 131/04; C09D 133/02; B05D 1/02; E04B 1/66; E04B 2/30; E04B 1/76; E04B 1/78; E04B 2/52; E04B 2/54; C09D 5/02; E04B 1/64

(52) U.S. Cl. CPC C09D 131/04; C09D 5/028; C09D 133/02; B05D 1/02; E04B 1/66; E04B 1/64; E04B 1/7625; E04B 1/78; E04B 2/52; E04B 2/54; E04B 2/30

(57) ABSTRACT

A coating composition for forming a barrier membrane (16) on an exterior wall (10) of a building includes a fluid mixture of water, a binder, and at least about 3 wt % of an alcohol. After spreading the mixture on the exterior wall (10), at least the binder forms the barrier membrane (16). A method of applying a membrane (16) composition to an exterior wall (10) of a building includes providing a first mixture including at least about 82 wt % of an alcohol, providing a fluid composition including a binder and water, mixing the first mixture and the fluid composition to form a second mixture having alcohol in an amount of at least about 3 wt %, and spreading the second mixture on the substrate.

### CROSS REFERENCE TO RELATED APPLICATIONS

This application claims priority to U.S. Provisional Patent Application Ser. No. 62/024,298, filed Jul. 14, 2014, the disclosure of which is incorporated by reference herein in its entirety.

### TECHNICAL FIELD

The present invention relates generally to building materials and methods for their application, and, more particularly, to barrier coating compositions and methods of applying coating compositions to buildings.

### BACKGROUND

As one aspect of building construction, the builder is typically required to apply a building envelope protection barrier to the building. In this regard, the exterior walls of the building must form a barrier resistant to weather and thereby efficiently separate interior spaces of a building, which are often temperature and humidity controlled environments, from the natural, uncontrolled external environment. The exterior wall of the building must therefore eliminate or at least limit air, vapor, and/or water permeation through the exterior wall and into the interior spaces. Limiting permeation can improve the energy-efficiency and the durability of a building. Overall, the building is likely to be more environmentally friendly than a building that does not sufficiently limit permeation.

To limit permeation, the exterior walls often include air and/or water vapor barrier membranes. With reference to FIG. 1, an exemplary exterior wall system 10 may include layers of different materials. For instance, the exterior wall system 10 may be constructed by erecting metal or wood stud walls 12 onto which exterior gypsum sheathing 14 may be installed. This may be followed by installation of an air, vapor, and/or water barrier membrane 16. Foam board insulation 18 may be secured to the barrier membrane 16 with a brick veneer layer 20 forming the environmentally exposed exterior surface 22 of the exterior wall system 10. The brick veneer layer 20 may be spaced apart from the foam board insulation 18 by fasteners 30. The spacing between the brick veneer layer 20 and the foam board insulation 18 forms an air cavity 24. The opposing interior wall surface 26 may be enclosed by interior gypsum sheathing 28. Usually, these types of exterior wall systems with air and/or water vapor barrier membranes may be employed in climates with long, cold winters or in persistently warm, humid climates. These membranes are designed to seal cracks and gaps between sheathing and external perforations in the wall that would otherwise permit penetration of air and water into the exterior wall. There are many types of barrier membrane materials that may be used to form the barrier membrane 16.

Preformed films having a polymer-modified asphalt adhesive on one surface are one type of membrane 16. The film may be coated with a disposable silicone paper release liner. The release liner is removed prior to application of the film to the exterior wall structure. This may be referred to as a “peel-and-stick” membrane. The preformed membrane may be applied to concrete, concrete block, gypsum sheathing, plywood, OSB, and many other building materials. The peel and stick membranes may be available in a roll that is unrolled and cut to size prior to adhering the membrane to the substrate. Joints between adjacent sheets of the membrane may be formed by overlapping the membranes or, where the edges of the membranes are butted together, an additional sealant may be applied to the butt joint to ensure complete protection.

Another type of membrane 16 is one that is fluid applied. As the term suggests, these barrier membranes are applied as a fluid and spread on a surface. Spreading may include rolling or spraying the fluid onto the surface. Once cured, the fluid forms a membrane. Advantageously, fluid-applied membranes are typically joint free. They do not require an additional joint sealing step as is often the case with the peel-and-stick films. However, similar to the peel-and-stick films, fluid-applied membranes may be applied to a variety of substrates. Once applied, the fluid air dries or cures to form the membrane 16.

Fluid-applied membrane compositions may be either solvent-based, water-based, 100% solids reactive type materials, or spray foam materials, among others. For solvent/water-based compositions, curing includes evaporation of the solvent or water under ambient conditions so that the membrane forms. Advantageously, water-based compositions lack the amount of volatile organic compounds associated with solvent-based fluids and are favored, for at least environmental reasons. However, water-based compositions are limited to use in ambient environments in which water evaporates quickly enough so that the membrane forms in a reasonable amount of time, which is dictated by the construction schedule. Thus, weather may preclude use of water-based fluids because of a lack of timely formation of the membrane. Solids reactive materials and spray foams may be multi-component materials and may have reactivity issues as ambient temperatures fall below 40° F. (4.4° C.). Furthermore, these types of air/vapor barrier systems may require more specialized application equipment and are generally more expensive than water-based systems by comparison.

In that regard, favorable ambient conditions for water-based fluids often include application temperatures of 40° F. (4.4° C.) or higher or where the substrate temperature is sufficiently above freezing and the humidity is relatively low so that water can evaporate. These ambient environmental restrictions limit use of water-based fluid compositions to applications in which the water can readily evaporate. In other words, freezing temperatures or a combination of near-freezing temperatures and high humidity can inhibit water evaporation. In addition to inhibiting timely formation of the barrier membrane, these conditions may also negatively affect the properties of any barrier membrane formed.

Another drawback to water-based fluid compositions is that they may degrade when exposed to freezing temperatures because they are susceptible to freezing. Exposure to these conditions may occur prior to application and/or during storage. While some water-based fluid compositions have some freeze-thaw stability, generally water-based fluids react negatively to being frozen. A fluid-applied membrane formed from a previously frozen and then thawed fluid composition may exhibit properties that are less than desirable as compared to a membrane formed from an unfrozen fluid composition. While freezing may not initially cause significant property degradation, exposure to multiple freeze-thaw cycles may progressively degrade or entirely destroy the fluid composition's utility in building envelope protection applications. In many instances, once the composition freezes, its reliability is questioned as it may not reliably produce a high-quality membrane.

A need therefore exists for water-based fluid compositions that are capable of being used at temperatures at or below freezing and in high humidity conditions.

### SUMMARY OF THE INVENTION

To these and other ends, embodiments of the present invention include a coating composition for use in the building industry and a method of applying the coating composition, including application to exterior walls of buildings at freezing and subfreezing temperatures.

In one embodiment of the invention, the coating composition is a fluid mixture that includes water, a binder forming composition, and a sufficient amount of an alcohol, each described below. In general, the coating composition is water-based and so lacks large quantities of solvents typically used in solvent-based compositions. The coating compositions according to the present invention may be advantageously used without generating significant quantities of volatile organic compounds. These water-based fluid-applied coating compositions may be termed low VOC compositions. As is described below, while the composition is water-based, unlike prior art water-based compositions, embodiments of the present invention do not behave like water-based compositions. For example, embodiments of the present invention resist freezing at temperatures substantially lower than the prior art compositions. As a result, the coating compositions according to embodiments of the present invention may be stored, applied, and cured at subfreezing temperatures while the membranes formed have predictable and reliable properties that meet or exceed building standards.

Further, barrier membranes formed from the water-based fluid-applied coating composition resist degradation due to exposure to water relatively soon after application, depending on application temperature and other environmental conditions, but are particularly well suited for subfreezing application temperatures. Thus, embodiments of the invention may be applied at up to 100 mils wet at near freezing temperatures (i.e., 32° F. (0° C.)) with less concern regarding exposure to rain and with less concern of sagging or running. Overall, embodiments of the present invention may be more environmentally friendly while exhibiting a robust range in application temperature, including subfreezing application temperatures, and enhanced environmental resistance soon after application. All of these characteristics benefit the contractor, who typically is responsible for application of the barrier membrane to a building, and the building owner.

### BRIEF DESCRIPTION OF THE DRAWINGS

The accompanying drawings, which are incorporated in and constitute a part of this specification, illustrate embodiments of the invention and together with the detailed description given below, serve to explain various aspects of the invention.

FIG. 1 is a cross-sectional elevation view of an exemplary exterior wall system; and

FIGS. 2-17 are photographs of exemplary water-based fluid applied compositions following application to a substrate.

### DETAILED DESCRIPTION

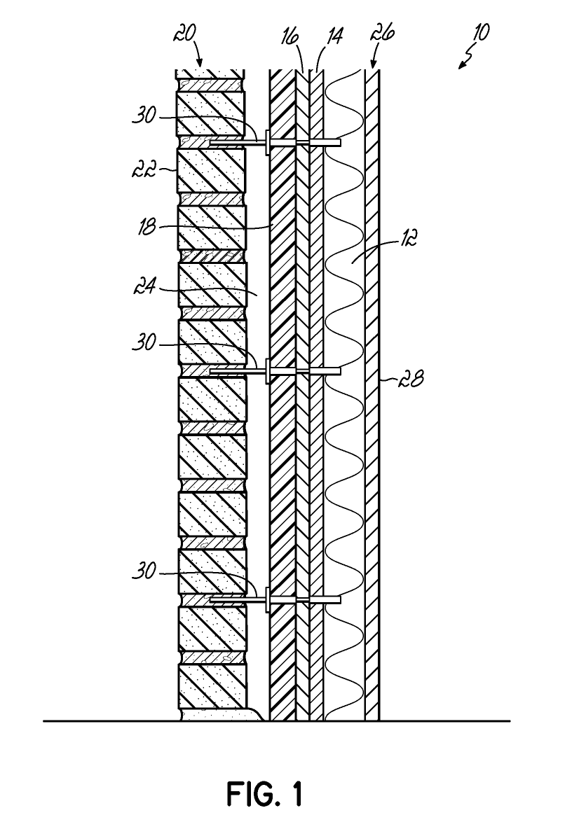

With reference to FIG. 1, in one embodiment of the invention, the coating composition may be utilized to form at least one of the layers in the construction of the exemplary exterior wall system 10. By way of example and not limitation, the coating composition may be applied to form a membrane 16 on the exterior gypsum sheathing 14, as shown. However, embodiments of the present invention are not limited to forming a membrane 16 in the exterior wall system 10 as the coating composition may be applied to other substrates. By way of example, in addition to the exterior gypsum sheathing 14, the coating composition may be applied to concrete, concrete block, plywood, oriented strand board (OSB), and many other building materials. Once cured, the coating composition may form a barrier membrane 16 that is impervious or at least resistant to any one or more of air, water vapor, and water. Furthermore, the barrier membrane may meet or exceed fire standards. Now embodiments of the coating composition will be more fully described.

In one embodiment of the invention, the coating composition is a fluid mixture that includes water, a binder forming composition, and a sufficient amount of an alcohol, each described below. The coating composition contains water so as to be water-based. Despite containing water as a substantial proportion, the coating composition may resist freezing for unexpectedly long periods. In this regard, the composition may be stored for months (e.g., two months or more) and the composition does not separate and may be otherwise stable. Thus, the composition has an unexpectedly long shelf life. In addition, during winter, the composition is unexpectedly more stable and, for example, may be stored at temperatures less than 32° F. (0° C.) for lengthy periods of time (e.g., overnight or longer at 25° F. (−3.9° C.)) and still be capable of forming a fluid-applied membrane on substrates that are at temperatures at or below freezing.

The amount of water in the coating composition may be sufficient to form a fluid with the other constituents of the coating composition, described below. In one embodiment, the coating composition may be an emulsion in which the water may in part form a continuous phase with one or more of the remaining constituents forming a discrete phase, that is, a discontinuous phase surrounded by water. By way of example only, the coating composition may include at least about 16 wt % water, between about 16 wt % and about 65 wt % water, and by way of further example, between about 16 wt % and about 35 wt % water. As another example, water may be present in the range of from about 14.5 wt % to about 24 wt %. Generally, as the percent of water increases beyond a certain minimum, the barrier membrane may not be as likely to form within a commercially acceptable timeframe (i.e., within a day or two) and the more susceptible the composition is to freezing.

As provided above, the coating composition also contains a sufficient amount of an alcohol. While it is believed that there are many alcohols that may be included, embodiments of the present invention may specifically include any single one or combination of the simple alcohols, such as, methanol, ethanol, and isopropyl alcohol. It will be appreciated however that higher alcohols, e.g., those containing 4 to 10 carbon atoms, may also be utilized. The amount of alcohol in the coating composition may be less than the amount of water in the coating composition. In one embodiment, the amount of alcohol is about half the amount of water. Too much alcohol in the coating composition may cause the composition to become unstable and crash, i.e., separate or solidify (the mixture may have a cottage cheese-like consistency) prior to application. The composition includes a sufficient amount of alcohol, which may be more than triple the amount of any alcohol than in other fluid-applied membrane compositions. The composition is stable and forms a membrane in a commercially acceptable time. By way of example only, the coating composition may include from about 3 wt % to about 22 wt % alcohol, from about 6 wt % to about 15 wt %, and by way of further example, from about 9 wt % to about 12 wt % alcohol. In one embodiment, the coating composition includes at least about 10 wt %, for example, from about 10.2 wt % to about 12% methanol and by way of further example from about 10.7 wt % to about 12%, or from about 11.1 wt % to about 11.6 wt % methanol. It will be appreciated that at amounts in excess of the range of 11 wt % to 12 wt %, sprayed coatings may run or sag when wet thicknesses approach the thickness needed to produce a one coat as-dried membrane. Wet thicknesses of about 140 mils (about 0.35 cm) are believed to produce a one coat dry thickness of about 80 mils (about 0.20 cm).

The coating composition further includes a binder. Generally, the binder forms the barrier membrane on a substrate upon evaporation of the majority of the water, alcohol, and other volatile constituents, if any. The binder may include one or more water soluble/dispersible monomers that polymerize during curing. By way of example only, the binder may include acrylic monomers and/or vinyl acetate monomers that polymerize or copolymerize with another monomer or polymer during curing as the volatile components (e.g., water and alcohol) of the coating composition evaporate. Exemplary commercially available polymers include Rovace™ 86, a vinyl-acrylic polymer from the Dow Chemical Company and Vinnapas® EF 575 an aqueous surfactant stabilized vinyl acetate-ethylene copolymer dispersion from Wacker Chemie AG. It will be appreciated that other monomers or other polymers may be usable according to embodiments of the present invention.

The coating composition may include a relatively large proportion of the binder. The amount of the binder may depend upon the application for the coating composition, the amount of filler material (described below), and other factors. In one embodiment, the binder forms the largest proportion by weight of the coating composition. By way of example only, the coating composition may include up to 50 wt % of binder, and by way of further example, the coating composition may include from about 25 wt % to about 45 wt % binder. The binder may be in the form of an emulsion as is known in the art which may include a substantial amount of water. By way of example, the binder may include about 45 wt % water and so contributes a large portion of the water to the coating composition.

Once cured, and by way of example only, the binder may form a vinyl acetate-based polymer, such as, a vinyl acetate acrylic copolymer containing membrane on the substrate. It will be appreciated that embodiments of the present invention are not limited to specific vinyl acetate or acrylate polymers or acetate/acrylate copolymers, as other polymers may be formed from the binder.

The coating composition may further include one or more secondary constituents that may be selected from surfactants, emulsifiers, waxes, plasticizers, UV stabilizers, biocides, or combinations thereof. The secondary constituents may be included in the binder and modify the binder as is known in the art. While the relative amounts of the secondary constituents may vary, in one embodiment, the coating composition includes less than about 15 wt % of the secondary constituents. By way of example only, the coating composition may include less than about 2.3 wt % of UV stabilizer, one or more biocides, ethylene glycol, and ammonia. As such, the one or more secondary constituents may form only a minority portion of the binder.

The coating composition may include a thickener. The thickener may be added in order to increase the viscosity of the coating composition for application to a particular surface. For example, where the substrate is vertically oriented, nonporous, and/or smooth, the thickener may be added to reduce the likelihood that the coating composition drips or puddles on the substrate during evaporation and prior to curing. Thus, the thickener may facilitate uniform formation of the barrier membrane on building walls. Exemplary thickeners may include anionic, nonionic, or associative thickeners, for example, a commercially available anionic thickener includes Acrysol™ ASE-60 and a nonionic thickener includes Acrysol™ 6038A. Each of which are commercially available from The Dow Chemical Company. By way of example only, the coating composition may include up to about 2 wt % thickener which may depend on the ambient conditions during application, the method of application of the coating composition, and the remaining constituents of the coating composition. It will be appreciated that as the amount of the alcohol and/or the water increases, the viscosity of the coating composition may decrease. As the viscosity of the coating composition decreases, the amount of the thickener may increase. In one embodiment, the coating composition includes from about 1.3 wt % to about 1.8 wt % thickener, for example, about 1.7 wt % thickener.

The coating composition may include a filler material. The filler material is a solid inert material in particulate form. The average particle size of the filler material may vary and may depend upon the composition of the filler material, its cost for different average particle sizes of the filler material, and the application for which the coating composition is made. The filler material may have a particle size that lends itself to remaining suspended in the remaining constituents of the coating composition so as to form a fluid composition that is applicable (e.g., sprayable) on the substrate without prior mixing or with a minor amount of mixing prior to application. The filler material may include particles that are inert in the composition. When the coating composition cures to form a membrane, these particles may provide vapor permeability to the membrane. Particles may include inorganic materials, such as, ceramic microspheres; glass beads (either hollow or solid); silica; calcium carbonate; clays, such as, mica, talc, or gypsum; or a combination thereof. By way of example only, the filler material may be a powdered calcium carbonate, such as, Hubercarb® M300 Series calcium carbonate available from Huber Engineered Materials.

It will be appreciated that while the amount of the filler material in the coating composition is described as a weight percent, the weight of the filler material in the composition may depend on the density of the filler material. In that regard, the weight of the filler material in the coating composition may vary from relatively low weight percentages for low-density filler materials to relatively high weight percentages for high-density filler materials.

In one embodiment, where the filler material is predominantly calcium carbonate, the filler material is at least about 10 wt % (or an equivalent volume percent) of the coating composition. In yet another embodiment, the coating composition contains from about 25 wt % to about 45 wt % filler material. In yet another embodiment, the coating composition contains from about 24 wt % to about 32 wt % filler. The upper limit to the amount of filler material should not exceed an amount that negatively impacts application of the coating composition to a substrate, that inhibits the coating composition's capability of adhering to the substrate, or that negatively impacts another property of the membrane formed.

The coating composition may include an optional pigment that colors the barrier membrane. The pigment may be present in an amount sufficient to provide a visually distinctive color to the barrier membrane. By way of example only, the coating composition may include less than 0.5 wt % of the optional pigment and by way of further example may include less than about 0.05 wt % of the pigment. In one embodiment, the optional pigment provides a blue color to the barrier membrane.

In view of the above constituents, in one embodiment, the coating composition may be prepared by mixing all of the constituents together. The mixture may then be packaged and may be stored for weeks or months. In one embodiment, the mixture includes the following constituents in weight percent: vinyl acetate/acrylic copolymer (includes about 45 wt % water) 34.2%; filler 32.2%; additional water 8.1%; chlorinated paraffin 5.8%; plasticizer 5.4%; defoamer, nonionic surfactant and dispersant 0.8%; alkali swellable thickener 1.8%; methanol 11.1%; and balance one or more of a UV stabilizer, one or more biocides, ethylene glycol, and ammonia. The mixture may produce a barrier membrane consistently below about 15° F. (about −9.4° C.).

In view of the above constituents, in one embodiment, the coating composition may be prepared in at least 2 separate fluid parts that are mixed prior to application of the coating composition to the substrate. For example, a first part or primary part and a second part or admix part may be mixed to form the coating composition. The multiple parts may be kept separate from one another until just prior to application. Alternatively, the admix part and the primary part may be mixed and the coating composition may be stored for weeks or months due to the stability of the composition. The primary part of the coating composition may include water, binder, alcohol, filler material, and one or more secondary constituents as described above. In one embodiment, the primary part is Barritech VP, a vapor-permeable air barrier membrane composition that is commercially available from Carlisle Coatings and Waterproofing. Barritech VP includes about 37 wt % of a vinyl acetate acrylic copolymer, which may be about 45 wt % water; about 35 wt % of one or more fillers including calcium carbonate, hydrophilic fumed silica, clay, and pigment; about 11 wt % water; about 6.4 wt % of chlorinated paraffin; about 6 wt % plasticizer; about 0.9 wt % of a defoamer, a nonionic surfactant, and a dispersant; about 1.4 wt % of an alkali swellable thickener; about 1.8 wt % methanol; and a balance of other components including a UV stabilizer, one or more biocides, ethylene glycol, and ammonia. An admix part, which is added to the primary part, may include alcohol, one or more secondary constituents, and thickener.

The primary part and the admix part may be mixed according to any ratio that provides the constituents in the proportions identified above. Generally, according to one embodiment, the primary part forms a majority by weight of the coating composition. By way of further example only, and not limitation, a ratio of the primary part to the admix part by volume may range from about 10 to 1 to about 4 to 3. For embodiments that include multiple parts that are mixed prior to application, the rate at which the admix is added to the primary part and/or the amount of mixing may determine the consistency of the coating composition. In one embodiment, the primary part and the admix part are mixed together at a constant rate of about ½ gallon (about 1.9 liters) to about 4½ gallons (about 17 liters) of the primary part over about 8 minutes prior to being sprayed onto a substrate.

In addition, each of the primary part and the admix part may include similar constituents. While there may be some overlap in the constituents, that is, a constituent may be present in both the primary part and the admix part, the admix part may supply one or more constituents to the coating composition not found in the primary part and vice versa. The primary part may include selected constituents not found in the admix part.

In one embodiment, each of the primary part and the admix part may include an alcohol, but no other constituent is common to both the primary part and the admix part. By way of example only, the primary part may include a relatively small weight percentage of alcohol with the majority of the alcohol in the coating composition provided by the admix part. In this regard, the primary part may include less than about 5 wt % alcohol. The admix part may then contribute the majority of the alcohol in the coating composition. By way of further example only, the primary part may include less than about 2 wt % alcohol with the balance of the alcohol in the coating composition being provided by the admix part. In one embodiment, the primary part may include about 1.79 wt % methanol with the balance of the alcohol being provided by the admix part so as to provide a coating composition including an alcohol content of up to about 15 wt %. In this regard, the admix part may include up to 100 wt % methanol, and by way of further example, the admix may include from about 80 wt % to 100 wt % methanol. By way of example only, the admix may include 82 wt % or more of the alcohol or 94 wt % or more of the alcohol.

In addition, the admix part may include the thickener, described above. By way of example only, the admix part may include up to about 47 wt % thickener, up to about 24 wt % thickener, up to about 18 wt % thickener, or up to about 6 wt % thickener. The admix part may include other minor constituents (less than 2 wt % of the admix), including, for example, ammonia and/or monoethanolamine.

As described above, the coating composition is spread on a substrate and then cured. Spreading the coating composition on the substrate may include rolling the coating composition on the substrate, much like painting, or spraying the coating composition onto the substrate. The thickness of a layer of the coating composition on the substrate determines the thickness of the barrier membrane 16 (FIG. 1). Generally, a layer of the coating composition is thicker than the barrier membrane. The coating composition may be applied to a wet thickness of at least about 45 mil (about 0.045 inch or about 0.11 cm)) thick but may be considerably thicker, for example, up to 80 or 100 mil depending on the specifications for the building. Thinner barrier membranes are also possible. The thickness depends on the application for which the barrier membrane is to be used. It will be appreciated that evaporation of the volatile constituents of the coating composition may result in about 40% to about 50% reduction in thickness during evaporation and curing.

The coating composition may be supplied in containers, such as, in 5 gallon (19 liters) pails or in drums of larger volume, and sprayed with a conventional airless spray equipment. By way of example, the coating composition may be sprayed with a Graco GH 733, GH 833, Ultimate MXII 695, or GMAX 7900 pump with a Graco Silver Plus Gun. Other spray guns that may be usable with the coating composition of the present invention include a Graco IronMan 300E Airless Sprayer. Orifice size used in the spray guns may vary considerably, however, by way of example, the Graco IronMan 300E Airless Sprayer may be utilized with a 627 tip.

The coating composition may alternatively be formed by co-spraying each of the constituent parts. For example, the primary part and the admix part may be simultaneously co-sprayed onto the substrate. Generally, in co-spraying, a primary stream of fluid is merged with and a second stream of fluid. The primary and secondary streams are mixed together so that a mixed stream contacts the substrate. Thus, co-spraying the primary part as the primary stream and the admix part as a secondary stream results in the mixing of the primary part and the admix part to form the coating composition immediately prior to forming a coating on a substrate. In one embodiment of the invention, the primary part and a thickener-free admix part may be co-sprayed. Generally, using a co-spray gun may be sufficient to co-spray the primary and secondary streams. An exemplary commercially available co-spray gun is the Ironman 300E from Graco. By way of example and not limitation, co-spray systems capable of co-spraying the primary part and the admix part include the GH 733 manufactured by Graco.

Advantageously, the coating composition may be spread onto a substrate, for example, by spraying or rolling, when the ambient temperature, substrate temperature, and/or the coating composition temperature is at or below freezing (i.e., at or below 32° F. (0° C.)). In one embodiment, as long as the substrate is free of ice, and depending on other ambient conditions, like humidity, the coating composition may be spread on the substrate at temperatures in the single digits, i.e., below 10° F. (−12° C.). The applied coating composition unexpectedly forms a protective film after a few minutes and may dry and cure over a period of a few hours, typically 4 to 8 hours, or over a period of 2 days or less. Generally, as the temperature approaches 32° F. (0° C.) from single digit temperatures, the applied coating composition more quickly forms the membrane 16. By way of example, the applied coating composition may be applied at 80 mils (0.20 cm) wet and be dry in about 4 hours at an ambient temperature in the range of about 20° F. (about −6.7° C.) to about 25° F. (about −3.9° C.). By way of further example, the applied coating composition may form a surface film when applied at 80 mils (0.20 cm) wet and resist water spray after drying/curing for 16 hours in the range of about 5° F. (about −15° C.) to about 10° F. (about −12° C.). This performance is more typical of solvent-based compositions.

In order to facilitate a more complete understanding of the embodiments of the invention, the following non-limiting examples are provided.

### EXAMPLES 1-21

The Examples 1-21 were prepared with the following methodology in a laboratory setting. The compositions were mixed according to the amounts and ratios indicated at room temperature. Once prepared, the mixture was spread via a drawn-down bar or with a tongue depressor on a galvanized steel substrate held horizontally to a target wet thickness of about 45 mil (0.11 cm). The galvanized substrate was initially cooled to the temperature indicated so that the room-temperature mixture was spread on a pre-chilled substrate. Dry time was determined by touch and by observing any degradation to the membrane after a 15 minute water wash.

### EXAMPLE 1

An exemplary coating composition of a mixture of 4 parts by weight Barritech VP (commercially available from Carlisle Coating and Waterproofing), to 3 parts of an admix of 48.8 wt % methanol, 14.6 wt % TXIB™ (a low viscosity plasticizer from Eastman Chemical Company), and 36.6 wt % Acrysol™ 6038A (a thickener available from The Dow Chemical Company) was prepared. After spreading on the galvanized steel, the coating was placed into a refrigerator at 36° F. (2.2° C.). The coating composition was determined to be dry in about 4 hours. It is noted that Barritech VP freezes in about 3 hours at 25° F. (−3.9° C.).

### EXAMPLE 2

An exemplary coating composition of a mixture of 29 parts by weight Barritech VP to 8 parts of an admix of 48.8 wt % methanol, 14.6 wt % TXIB™, and 36.6 wt % Acrysol™ 6038A was prepared. After spreading on the galvanized substrate, the coating was placed into a refrigerator at 36° F. (2.2° C.). The coating composition was determined to be dry in about 4 hours.

### EXAMPLES 3 AND 4

The coating compositions of Examples 1 and 2 were prepared. After individually spreading the coating compositions on separate galvanized substrates, the individual coatings were placed into a refrigerator at 25° F. to 30° F. (−3.9° C. to −1.1° C.). The coating compositions were determined to be dry in about 24-48 hours.

### EXAMPLES 5 AND 6

The coating compositions of Examples 1 and 2 were prepared. After individually spreading the coating compositions on separate galvanized substrates, the individual coatings were placed into a refrigerator at 25° F. (−3.9° C.). The coating compositions were determined to be dry in about 48 hours.

### EXAMPLE 7

An exemplary coating composition of a mixture of 10 parts by weight Barritech VP, commercially available from Carlisle Coating and Waterproofing, to 1 part of an admix of 52 wt % methanol and 48 wt % Acrysol™ ASE-60 (from The Dow Chemical Company) was prepared. After spreading on the galvanized substrate, the coating was placed into a refrigerator at 25° F. (−3.9° C.). The coating composition was determined to be dry in 72 hours or more.

### EXAMPLE 8

An exemplary coating composition of a mixture of 10 parts by weight Barritech VP, commercially available from Carlisle Coating and Waterproofing, to 1 part of an admix of 51.4 wt % methanol, 47.44 wt % Acrysol™ ASE-60 (from The Dow Chemical Company), 0.74 wt % ammonia, and 0.42 wt % Monoethanolamine (i.e., NH₂—CH₂—CH₂—OH, available from The Dow Chemical Company) was prepared. After spreading on the galvanized substrate, the coating was placed into a refrigerator at 25° F. (−3.9° C.). The coating composition was determined to be dry in 72 hours or more.

### EXAMPLES 9 AND 10

The coating compositions of Examples 7 and 8 were prepared. After individually spreading the coating compositions on separate galvanized substrates, the individual coatings were placed into a refrigerator at 19° F. to 25° F. (−7.2° C. to −3.9° C.). The coating compositions were determined to be dry in about 94 hours.

### EXAMPLES 11 AND 12

The coating compositions of Examples 7 and 8 were prepared. After individually spreading the coating compositions on separate galvanized substrates, the individual coatings were placed into a refrigerator at 19° F. to 25° F. (−7.2° C. to −3.9° C.). The coating compositions were determined to be dry in about 84 hours.

### EXAMPLES 13 AND 14

The coating compositions of Examples 7 and 8 were prepared. After individually spreading the coating compositions on separate galvanized substrates, the individual coatings were placed into a refrigerator at 19° F. to 25° F. (−7.2° C. to −3.9° C.). The coating compositions were determined to be dry in about 24 hours or more.

### EXAMPLES 15 AND 16

The coating compositions of Examples 7 and 8 were prepared. After individually spreading the coating compositions on separate galvanized substrates, the individual coatings were placed into a refrigerator at 53° F. (12° C.). The coating compositions were determined to be dry in about 3.3 hours.

### EXAMPLES 17 AND 18

The coating compositions of Examples 7 and 8 were prepared. After individually spreading the coating compositions on separate galvanized substrates, the individual coatings were placed into a refrigerator at 34° F. to 39° F. (1.1° C. to 3.9° C.). The coating compositions were determined to be dry in about 7 hours.

### EXAMPLES 19 AND 20

The coating compositions of Examples 7 and 8 were prepared. After individually spreading the coating compositions on separate galvanized substrates, the individual coatings were placed into a refrigerator at 34° F. to 39° F. (1.1° C. to 3.9° C.). The coating compositions were determined to be dry in about 7 hours.

### EXAMPLE 21

An exemplary coating composition of a mixture of 10 parts by weight Barritech VP (commercially available from Carlisle Coating and Waterproofing) to 1 part of an admix of 76 wt % methanol and 24 wt % Acrysol™ ASE-60 (from The Dow Chemical Company) was prepared. After spreading on the galvanized substrate, the coating was placed into a refrigerator at 34° F. to 39° F. (1.1° C. to 3.9° C.). The coating composition was determined to be dry in 8 hours.

### EXAMPLES 22-30

The Examples 22-29 were prepared with the following methodology and field tested. The compositions were mixed according to the amounts and ratios indicated at the indicated ambient temperature. Once prepared, the mixture was sprayed under the stated weather conditions onto a vertically oriented substrate. The substrate was at the ambient temperature indicated. Dry time was determined by touch and by observing degradation during a water wash test.

### EXAMPLES 22 AND 23

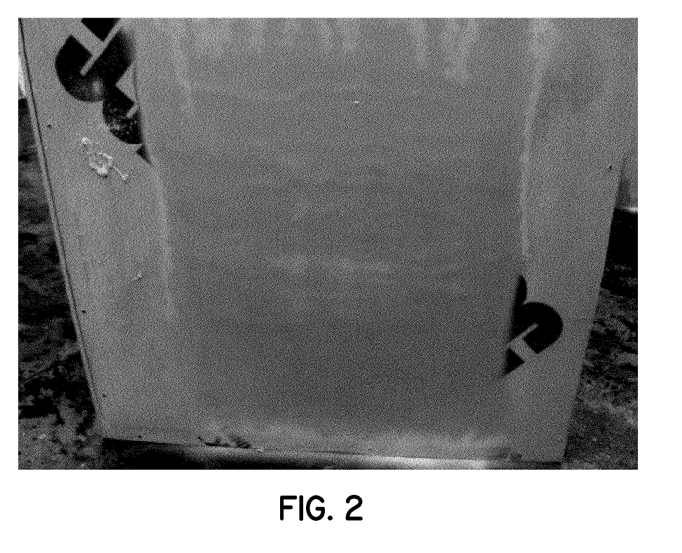

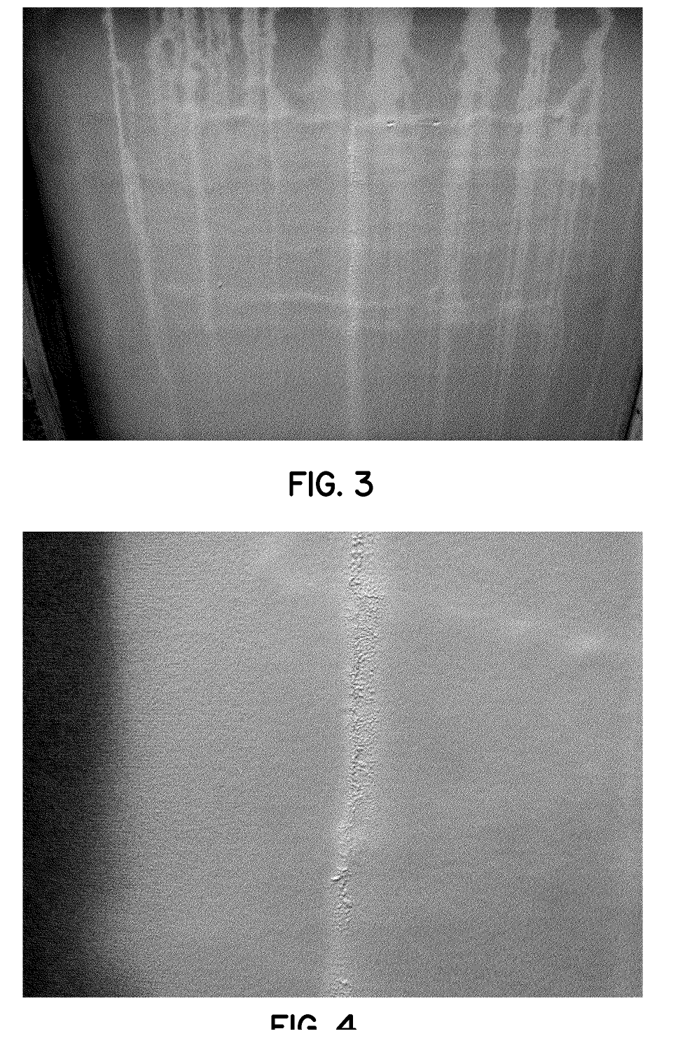

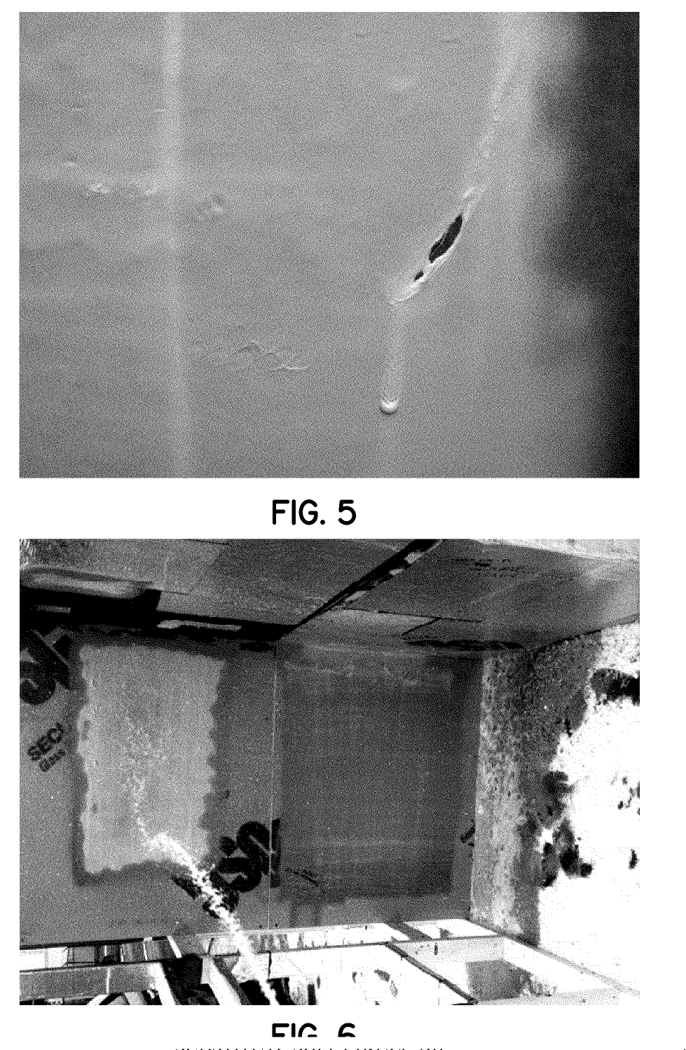

An exemplary coating composition of a mixture of 10 parts by weight Barritech VP (commercially available from Carlisle Coating and Waterproofing) to 1 part of an admix of 92 wt % methanol and 8 wt % Acrysol™ ASE-60 (from The Dow Chemical Company) was prepared. The composition of Example 22 was prepared outside and it was 26° F. (−3.3° C.) at the time of spraying, and the composition of Example 23 was prepared inside and it was 40° F. (4.4° C.) at the time of the spraying. Each composition was sprayed to about 80 mils (about 0.20 cm) wet onto a sheathing panel (FIGS. 2-5), commercially available from USG Corporation and onto a gypsum board commercially available from National Gypsum. The ambient temperature of the sheathing panel, gypsum board, and during spraying was about 30° F. (about −1.1° C.). The coating composition was sprayed onto the respective substrates with few craters and formed a film within about 10 minutes. After about 4 hours following spraying, each film was sprayed vigorously with water. No degradation was observed.

After 24 hours, each of the films was nearly dry. The weather conditions during the 24 hours from the time of spraying were overcast, slightly windy, and rainy with an ambient temperature of about 37° F. (about 2.8° C.) and a substrate and film temperature of about 32° F. (about 0° C.).

After 24 hours, the film blanched but did not wash off after washing thoroughly with water for 10 minutes. Only after peeling off a surface skin of the film was wet material revealed which then washed off in small chunks. The film appeared to have good water resistance when sprayed to about 80 mils (about 0.20 cm) thickness and allowed to dry for 24 hours.

### EXAMPLE 24

An exemplary coating composition of a mixture of 10 parts by weight Barritech VP, commercially available from Carlisle Coating and Waterproofing, to 1 part of an admix of 92 wt % methanol and 8 wt % Acrysol™ ASE-60 (from The Dow Chemical Company) was prepared. The composition was mixed by adding about ½ gallon (about 1.9 liters) of the admix quickly to about 4½ gallons (about 17 liters) of Barritech VP. The resulting mixture had the appearance of poorly mixed dough but was not solid. The composition was sprayed to a wet thickness of approximately 60 mils (approximately 0.15 cm) on a USG sheathing panel. Ambient temperature during spraying was in the single digits (generally less than 10° F. (−12° C.)) with a strong wind. After about 24 hours, the sprayed film unexpectedly dried to a tough, elastomeric film.

### EXAMPLE 25

After about 24 hours, the composition of Example 24 was not frozen and so was remixed with a mixer mounted on a drill. Further mixing of the dough-like mixture provided a smooth, more easily sprayable composition. Total mix time between initial mixing and remixing was about 15 minutes. The remixed composition was sprayed on a USG sheathing panel at an ambient temperature in the low to mid 20s (° F.) under fairly clear skies.

A film formed with a noticeable skin in about 15 minutes. After about 1 hour after spraying, it was believed that the film formed on a South/West exposed panel would likely handle direct water spray without washing off, although the film was not tested with a water spray. The air temperatures on the South/West exposed panel were estimated to be about 15° F. (about −9.4° C.) above ambient. A film that formed on a sample with North/East exposure (where air temperature was closer to ambient temperature) was still fairly wet, but the surface skin was fairly strong.

### EXAMPLE 26

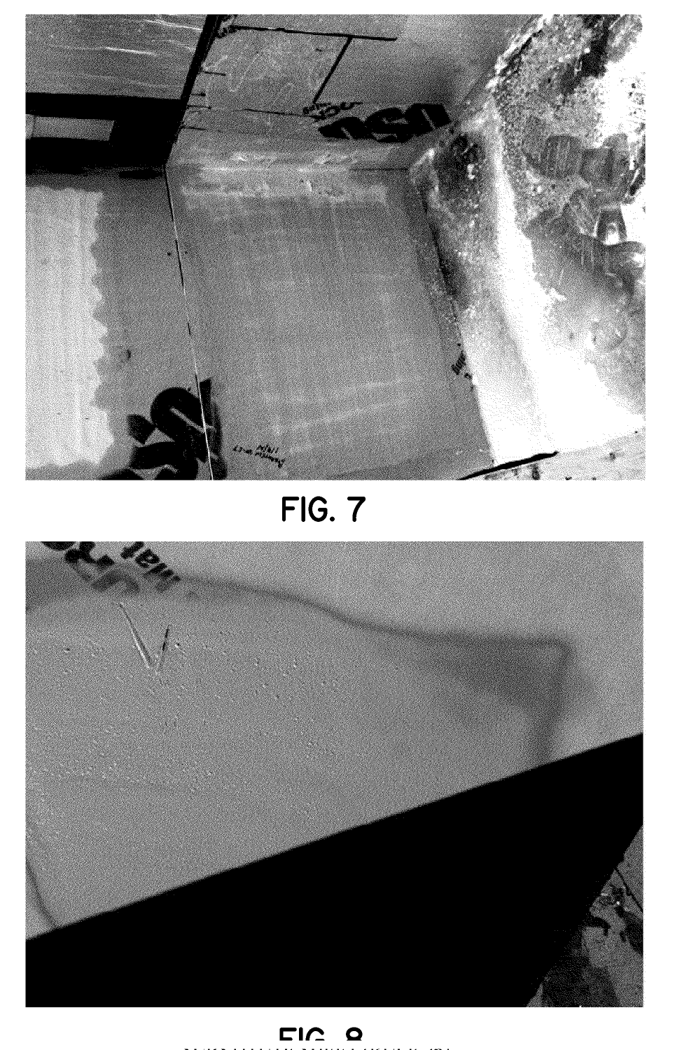

About 4 or so hours after Example 25 was sprayed (Example 25 was sprayed in the morning), an exemplary coating composition of Example 24 was prepared by slowly adding the admix to the Barritech VP while mixing over a period of about 8 minutes. After mixing, the composition was sprayed onto a wall mock-up. See FIGS. 6 and 7. The conditions during spraying were similar to those of Example 25. Example 26 was sprayed in the afternoon on the same day that Example 25 was sprayed.

After being exposed to below freezing temperatures overnight, Examples 25 and 26 were subject to a water spray test. It was estimated that the water spray testing was performed at about 18 hours after spraying for Example 26 and closer to 22 hours for Example 25.

Referring to FIG. 6, the upper applied area is Example 26 and the lower area is Example 25. It was noted that Example 26 had a fairly robust skin, but the skin broke down under the water spray test and was completely gone after 5 or 6 minutes of exposure to the water spray. Example 25 resisted the water spray nearly uniformly across its surface with one exception. On the right side of the lower applied area (Example 25) a couple of inside corner flashing details were done with Liquifiber and the applied coating was relatively thick so that it was still wet enough that the water spray removed the skin resulting is a localized failure of the coating.

It was also noted that after exposure to the water spray, in which the outer light blue material was washed away, Example 26 included a darker blue layer underneath immediately adjacent the USG sheathing panel. The water spray did not affect the darker blue coating. It was concluded that a thin layer below the skin layer had cured and would not re-emulsify during water spray. Using a comb gage, it was determined that the dark blue layer was about 20 mils (0.05 cm) thick (dry). It was contemplated that the USG sheathing wicked water from the film so that it more quickly cured.

### EXAMPLE 27

An exemplary coating composition of a mixture of 10 parts by weight Barritech VP (commercially available from Carlisle Coating and Waterproofing) to 1 part of an admix of 94 wt % methanol and 6 wt % Acrysol™ ASE-60 (from The Dow Chemical Company) was prepared. The composition was mixed by adding about ½ gallon (about 1.9 liters) of the admix to about 4½ gallons (17 liters) of Barritech VP. The composition was sprayed to a wet thickness of approximately 80 mils (approximately 0.20 cm) on a USG sheathing panel. See FIG. 8. Ambient temperature during spraying was 18° F. to 20° F. (−7.8° C. to −6.7° C.).

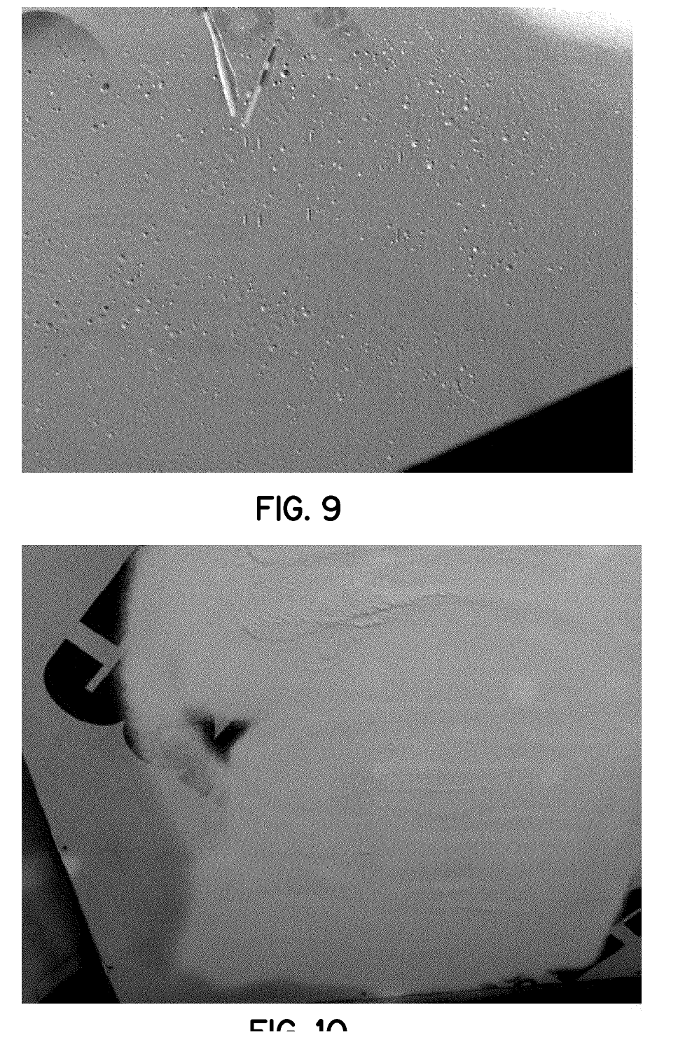

After about 15 hours, with temperatures during that period ranging from about 18° F. (about −7.8° C.) to about 20° F. (about −6.7° C.) and with the panels in the shade, the film was almost completely cured and areas that were not cured were incredibly tough. See FIG. 9.

### EXAMPLE 28

An exemplary coating composition was co-sprayed under the same ambient weather conditions as Example 27.

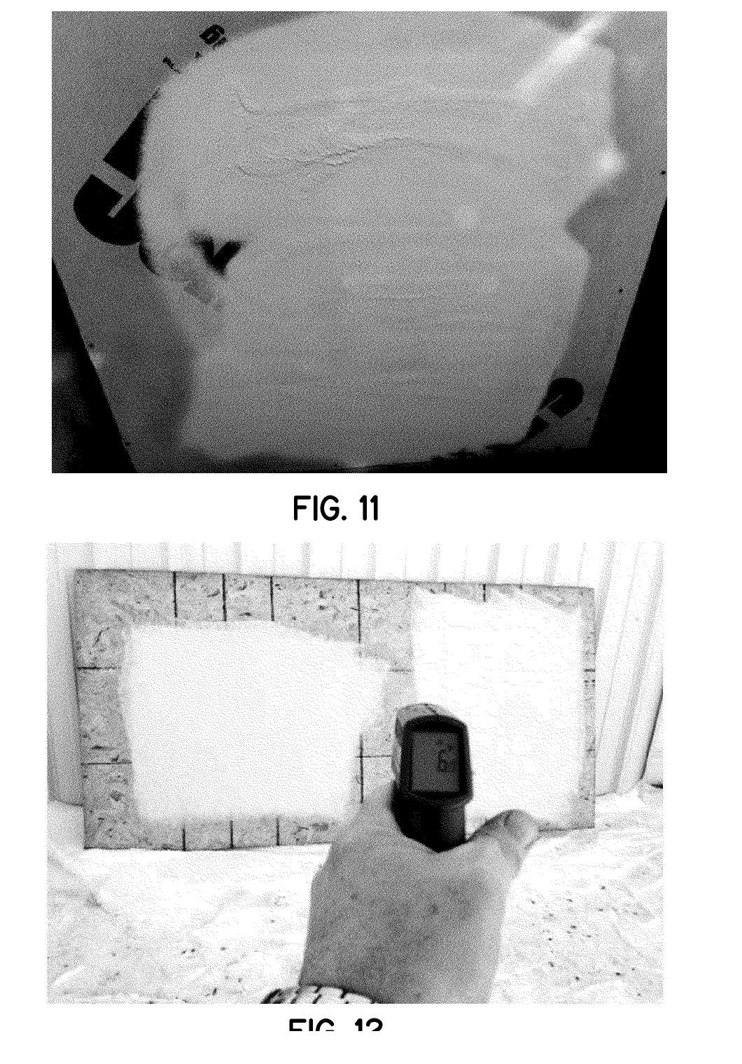

Rather than mixing the Barritech VP and admix prior to spraying, the admix was co-sprayed with the Barritech VP. In this regard, a Graco Ironman 300E with a 627 tip was utilized to co-spray the admix with the Barritech VP. See FIG. 10. About 1,495 g (about 53 ounces) of the admix was co-sprayed with about 2 gallons (about 7.6 liters) of the Barritech VP. Some equipment difficulties were noted with co-spraying the admix with the Acrysol™ ASE-60. After drying overnight, the co-sprayed film was about three-quarter cured. See FIG. 11.

### EXAMPLE 29

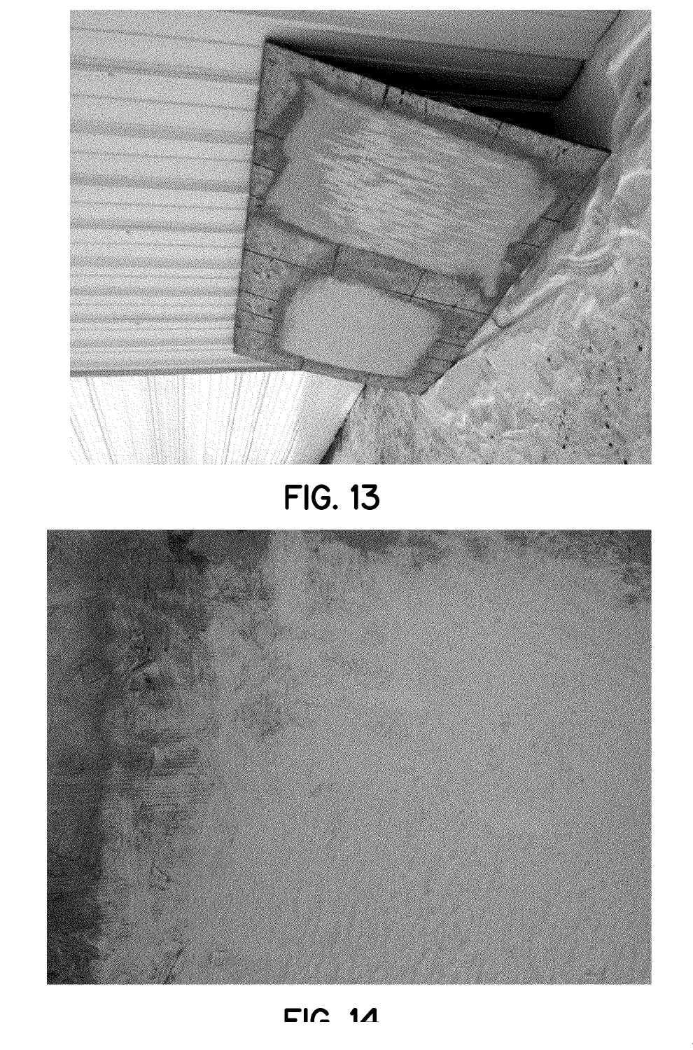

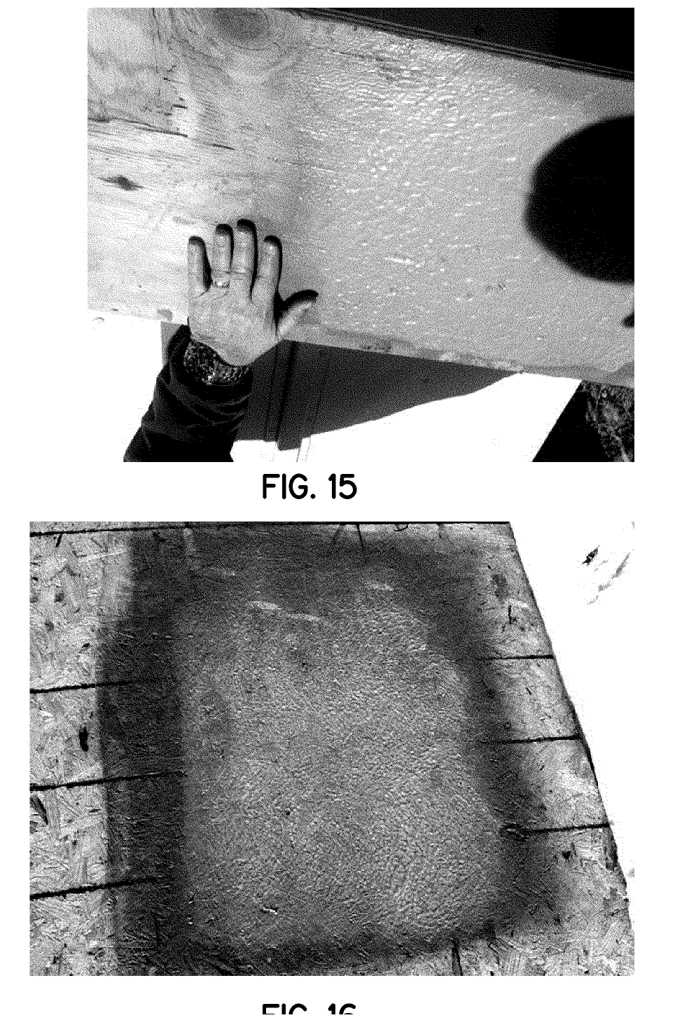

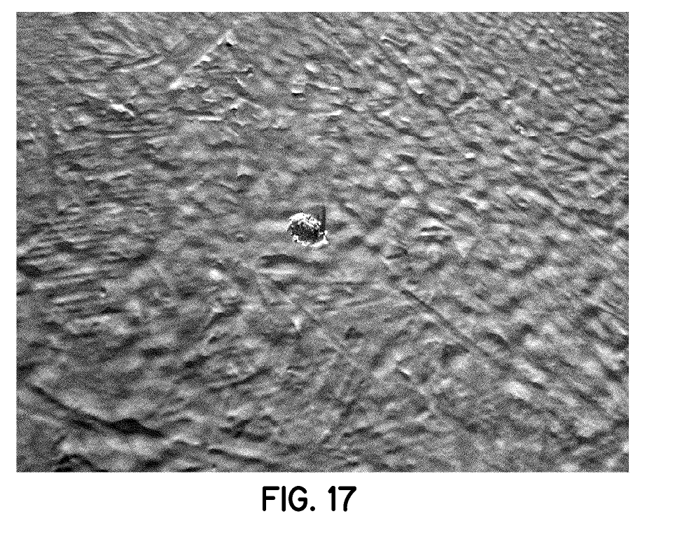

An exemplary coating composition of Example 27 was prepared. The composition was then sprayed onto OSB (see FIGS. 12-14 and 16) and plywood (see FIG. 15) at ambient temperatures ranging from about 5° F. (about −15° C.) to about 15° F. (about −9.4° C.). It was noted that the composition did not freeze at these temperatures. After spraying and setting overnight, the sprayed films had a “cheesy” texture and were nearly tack-free.

During a water test, one film that was in constant shade for 24 hours and applied at 9° F. (−13° C.) washed off. The sample that was set in the sun did not wash off during the water test. Instead, the film formed white streaks, but it was believed that the film would eventually cure.

### EXAMPLE 30

An exemplary coating composition of a mixture of about 10 parts Barritech VP to about 1 part admix of 100 wt % methanol was prepared. The composition was then sprayed to a wet thickness of about 60 mils (about 0.15 cm) onto OSB at subfreezing temperatures.

After setting overnight and into an afternoon, during which temperatures warmed to about 50° F. (about 10° C.), the film was firm but had not completely cured. The film was exposed to some sun during that period but was in the shade for most of that time. It was noted that some of the sprayed film that measured over 100 mils (0.25 cm) wet was really soft.

The films were sprayed with water from a hose during which the film quickly discolored but did not run.

In view of the above, coating compositions according to embodiments of the present invention may extend the time period during which a building may be constructed. In other words, ambient environmental conditions associated with fluctuations in seasons have less of a negative effect on application of water-based fluid-applied compositions according to embodiments of the present invention. Thus, water-based fluid-applied compositions may facilitate construction of buildings during relatively cold environmental conditions not before possible while assuring barrier membrane formation and performance typically associated with membranes applied during more favorable, i.e., warmer and less humid, temperatures.

While the present invention has been illustrated by a description of various embodiments and while these embodiments have been described in some detail, it is not the intention of the inventors to restrict or in any way limit the scope of the appended claims to such detail. Additional advantages and modifications will readily appear to those of ordinary skill in the art. The various features of the invention may be used alone or in any combination depending on the needs and preferences of the user.

What is claimed is:

1. A coating composition for forming a barrier membrane on an exterior wall of a building, the composition comprising:
a fluid mixture of water, a binder, and a sufficient amount of alcohol of at least about 3 wt %,
wherein after spreading the mixture on the exterior wall, at least the binder forms the barrier membrane.

2. The composition of claim 1, wherein the fluid mixture is at least about 16 wt % water.

3. The composition of claim 1, wherein the fluid mixture is between about 16 wt % and about 35 wt % water.

4. The composition of claim 1, wherein the fluid mixture is from about 3 wt % to about 22 wt % alcohol.

5. The composition of claim 1, wherein the fluid mixture includes alcohol in the range of about 10 wt % to about 12 wt %.

6. The composition of claim 5, wherein the fluid mixture includes water in the range of about 14.5 wt % to about 24 wt %.

7. The composition of claim 1, wherein the binder includes a vinyl acetate acrylic copolymer.

8. The composition of claim 1, wherein the amount of water is greater than the amount of the alcohol.

9. The composition of claim 1, further including a thickener present in an amount from about 1.3 wt % to about 1.7 wt %.

10. The composition of claim 1, wherein the mixture includes from about 25 wt % to about 45 wt % of the filler.

11. The composition of claim 1, wherein the mixture includes from about 24 wt % to about 32 wt % of the filler.

12. A container filled with the composition of claim 1.

13. A method of forming a fluid-applied membrane on a substrate comprising:
while the substrate temperature is less than or equal to about 0° C., spreading the composition of claim 1 on the substrate, wherein following curing, the fluid-applied membrane forms on the substrate.

14. The method of claim 13, wherein spreading the mixture on the substrate includes rolling or spraying the mixture on the substrate.

15. A method of applying a membrane composition to a substrate of an exterior wall of a building, comprising:
providing a first mixture including at least about 82 wt % of an alcohol;
providing a fluid composition including a binder and water;
mixing the first mixture and the fluid composition to form a second mixture having alcohol in an amount of at least about 3 wt %; and
spreading the second mixture on the substrate.

16. The method of claim 15, wherein the second mixture includes from about 14.5 wt % to about 24 wt % water.

17. The method of claim 15, wherein mixing includes forming the second mixture with from about 3 wt % to about 22 wt % alcohol.

18. The method of claim 15, wherein mixing includes forming the second mixture with at least about 10 wt % to about 12 wt % alcohol.

19. The method of claim 15, wherein spreading includes spraying the second mixture and the substrate is a vertical exterior wall.

20. The method of claim 15, wherein spreading includes spreading the second mixture on a substrate at an ambient temperature of between about −15° C. and about −12° C.
